(19) United States
(12) Patent Application Publication
(10) Pub. No.: US 2018/0239364 A1
(43) Pub. Date: Aug. 23, 2018

(54) OPTIMIZING THE TRAJECTORY OF AN AIRCRAFT

(71) Applicant: THALES, COURBEVOIE (DE)

(72) Inventors: Guillaume MEULLE, TOULOUSE (FR); Enrique LASO-LEON, TOULOUSE (FR)

(21) Appl. No.: 15/753,537

(22) PCT Filed: Sep. 6, 2016
(86) PCT No.: PCT/EP2016/070980

§ 371 Date: Feb. 19, 2018

(30) Foreign Application Priority Data
Sep. 9, 2015 (FR) 1501864

(51) Int. Cl. G05D 1/06; G08G 5/00; G05D 1/00; G01C 21/20

(52) U.S. Cl. CPC G05D 1/0661; G08G 5/0065; G01C 21/20; G08G 5/0034; G05D 1/0005; G08G 5/0039

(57) ABSTRACT

A method for optimizing the trajectory of an aircraft comprises the steps of determining one or more reference criteria CiRef on the basis of a non-optimized initial trajectory; determining one or more initial constraints K′j on the basis of the initial trajectory; determining a criterion Ci according to an analytical function of the criteria CiRef; and, per iteration cycle, determining an optimized trajectory; determining intermediate constraints K′j on the basis of the optimized trajectory; minimizing the criterion Ci determined under the initial constraints K′j and the intermediate constraints K′j; determining q takeoff parameters Pi. Developments describe an incremental iteration of the method, an interruption by the pilot, the use of criteria comprising the fuel consumption, the acoustic noise level, the emission of chemical compounds, the level of wear of the engine, the use of a gradient descent and of diverse optimizations. System and software aspects are described.

### FIELD OF THE INVENTION

The invention relates to the field of avionics in general. The invention relates in particular to methods and systems for optimizing the trajectory of an aircraft according to various criteria, especially cost criteria.

### PRIOR ART

As regards commercial flight operations, strict constraints exist as regards noise measured on the ground in proximity to landing runways.

The optimization of the trajectory of an aircraft results from a compromise between various factors which may clash. For example, the minimization of the noise measured on the ground in proximity to the takeoff and landing zones is an objective or a constraint which conflicts with the fact that airlines generally seek to minimize the cost of operating the aircraft, for example by decreasing the fuel consumption or by optimizing the costs related to engine maintenance.

In general, a trajectory that makes it possible to economize on fuel will give rise to greater noise, and conversely a trajectory that consumes more fuel will be associated with lower noise for the neighborhood. The search for the identification of an optimal solution is a complex task.

More precisely, various approaches are known, each for solving a specific technical problem. For example, for the purpose of decreasing the quantity of fuel consumed, one generally employs maximum thrust and fast retraction of the lift-enhancing devices. In order to decrease the noise emitted by the aircraft, so-called “low noise” procedures (i.e. such as published) are flown. In order to reduce engine wear, reduced thrust is applied on takeoff, which makes it possible to substantially safeguard the engines from thermomechanical wear. Although these solutions are effective in their field of application, they exhibit the drawback of degrading the other components when considered in combination.

The published literature alludes to a few attempts to reconcile these various criteria, but these solutions generally require that prior computations be carried out on the ground. In certain other cases, interpolations are necessary during the flight (for example by means of tables), and this ultimately causes an unacceptable increase in the workload of the crew and does not necessarily culminate in an optimal solution.

According to an approach geared toward fuel consumption, the aircraft takes off at maximum power and accelerates as early as possible (within the safety limits authorized by the regulations). The maximum power being applied for a significant time interval, the engine wear is substantially increased and the noise perceived in proximity to the airport is of course heightened.

According to an approach geared toward noise minimization, the aircraft takes off at maximum power with the flaps deployed so as to have a steep climb slope and then reduces the thrust when the airplane passes in proximity to the point where the sound nuisance will be a maximum. Throttle being reduced earlier, the engines operate at a sub-optimal point and the deployed flaps induce a degradation of the lift-to-drag ratio and therefore heavier fuel consumption for a given energy saving. According to a variant, the airplane follows procedures defined by the ICAO, the objective of which is to safeguard the local residents near airports. These procedures compel aircraft to follow particular trajectories, called NADP (Noise Abatement Departure Procedure), which circumvent inhabited zones or impose a specific vertical profile. This results in a lengthening of the trajectory and therefore higher fuel consumption.

According to an approach geared toward reducing engine wear, reduced thrust is sometimes applied on takeoff. In general, this thrust corresponds to that which would be applied under the most limiting temperature conditions for a takeoff (to the mass of the day). This type of procedure is called “Assumed temperature” or “Flex Temperature”. This temperature will be called the fictitious temperature hereinafter in the document. The optimization applying only for the portion of takeoff before the thrust reduction (THR RED ALTITUDE), this approach leads to (i) using the entire utilizable runway length and climbing with a lower slope, which leads (ii) to using the engine in a sub-optimal manner from a thermodynamic point of view. Accordingly, the airplane will pass at a lower altitude above the point where the sound nuisance is the most annoying, therefore ultimately making more noise from the point of view of the ground, and moreover the fuel consumption will be higher for the same energy saving.

The patent literature comprises a few solutions for multicriterion optimization, that is to say aimed at achieving a compromise between the criteria cited above. For example patent document US20110060485 discloses a method of optimization and a device for an aircraft takeoff procedure, comprising means for determining the optimal values for the takeoff parameters, while adapting them to the real takeoff conditions. This solution is expensive in computation time and thus cannot be carried out on a flight deck. To allow its operational use, it requires a tabulation of the optimal solutions, which tabulation is carried out beforehand on the ground, as well as a subsequent step of reconstitution by interpolation (to correspond to the conditions of the day). This process—in addition to its high logistical and computational costs—leads, after the interpolation, to a sub-optimal solution. Patent document U.S. Pat. No. 8,527,119 describes a method for adjusting the parameters of a takeoff procedure initialized before the flight on the basis of initial airplane conditions, when said conditions change just before takeoff. This adjusting method does not allow computation of the optimal solution and still induces additional work on the part of the pilot (during a takeoff phase which is already intense in terms of cognitive load). Therefore, these known approaches comprise limitations.

A need exists for methods and systems for optimizing the trajectory of an aircraft.

### SUMMARY OF THE INVENTION

An exemplary embodiment of the disclosed method comprises in particular the employment of a so-called “parametric” optimizer, relying on a modeling of the operational costs. Its operational costs are associated with a numerical simulation of the trajectory which utilizes a model of performance (aerodynamic and propulsion) of the airplane. The steps of the method can comprise iterations to optimize the computed solutions.

Advantageously, the invention makes it possible to achieve a compromise between various parameters, which parameters comprise for example the operational cost associated with the trajectory (e.g. quantity of fuel consumed), the environmental cost (e.g. the emissions of pollutants and/or the noise perceived on the ground) and the cost associated with the maintenance of the engines.

Advantageously, the invention makes it possible to optimize fuel consumption while simultaneously ensuring that the noise emitted by the airplane will not be greater than it would be if the trajectory were not optimized.

Advantageously, the initial technical problem of multicriterion optimization is solved in a manner compatible with the requirement of onboard use, that is to say performed within the flight deck. Commonplace computation means can be used (in particular a computer of portable type of standard computation power). The fast computation of the steps of the method makes it possible to provide an optimal solution under real mission conditions, i.e. without needing to resort to precomputed solutions. The steps of the method being able to form the subject of fast computations it is possible to identify an optimal trajectory solution taking into account the latest information available as regards the mission. Stated otherwise, the method according to the invention advantageously allows an exact and optimal solution to be obtained in a time compatible with the constraints imposed on crews (that is to say and for example with no need for the pilot to have to conduct interpolation tasks in a pre-established results table). The determination of an optimal solution can also satisfy constraints or objectives given by or for the air transporter (e.g. reduction in the operational flight costs and concomitant satisfaction of the imposed constraints).

Advantageously, combined with the iterative optimization of the solutions, the parametric optimization makes it possible to obtain a computation time compatible with the operations carried out by a crew in the time interval devoted to flight preparation on limited computation resources. In particular, the use of a parametric optimization process 310 (e.g. of gradient type) makes it possible to obtain an appreciably shorter computation time than that disclosed in the prior art (for example according to US20110060485).

### DESCRIPTION OF THE FIGURES

Various aspects and advantages of the invention will become apparent in support of the description of a preferred but nonlimiting mode of implementation of the invention, with reference to the figures hereinbelow:

FIG. 1 shows a basic diagram of the invention;

FIGS. 2A and 2B illustrate examples of computations conducted in parallel or in series, for example according to an implementation with several processors or processor cores;

FIG. 3 illustrates examples of sub-steps for the optimization;

FIG. 4 illustrates fuel consumption as a function of altitude and of distance flown;

FIG. 5 illustrates the evolution of the fictitious temperature;

FIG. 6 illustrates an example of taking the fictitious temperature into account to optimize the trajectory.

### DETAILED DESCRIPTION OF THE INVENTION

There is disclosed a method for optimizing the trajectory of an aircraft, comprising the steps consisting in determining one or more reference criteria CiRef on the basis of a non-optimized initial trajectory; determining one or more initial constraints K′j on the basis of the initial trajectory; determining a criterion Ci according to an analytical function of said criteria CiRef; and, per iteration cycle, determining an optimized trajectory; determining intermediate constraints K′j on the basis of the optimized trajectory; minimizing the criterion Ci determined under the initial constraints K′j and the intermediate constraints K′j; determining q takeoff parameters Pi. Developments describe an incremental iteration of the method, an interruption by the pilot, the use of criteria comprising the fuel consumption, the acoustic noise level, the emission of chemical compounds, the level of wear of the engine, the use of a gradient descent and of diverse optimizations. System and software aspects are described.

There is disclosed a method for optimizing the trajectory of an aircraft, comprising the steps consisting in receiving (the coordinates or information relating to) a non-optimized initial trajectory according to a published flight procedure; determining (or computing) one or more reference criteria CiRef on the basis of said non-optimized initial trajectory; said criteria CiRef being determined for the takeoff and/or climb portion of said non-optimized initial trajectory; determining one or more initial constraints K′j on the basis of the non-optimized initial trajectory; determining a criterion Ci according to an analytical function of said criteria CiRef; and, per iteration cycle, i) determining an optimized trajectory; ii) determining intermediate constraints K′j on the basis of said optimized trajectory; iii) minimizing said criterion Ci determined under the initial constraints K′j and the intermediate constraints K′j; iv) determining q takeoff parameters Pi.

The non-optimized initial trajectory is received from a flight procedure published by the air traffic control. This non-optimized trajectory is computed by numerical integration of a system of differential equations on the basis of the flight data.

The method can advantageously optimize various flight phases. The method according to the invention can in particular optimize the takeoff and/or the climb (phase before the so-called “cruise” flight phase).

The method according to the invention makes it possible to determine as output various takeoff parameters (such as speed, target altitude, engine control) which make it possible to obtain an optimized trajectory, in regard to optimization criteria and constraints or limit values.

More precisely, the method according to the invention proceeds by iteration. By progressively incrementing the number of parameters to be optimized (from 1 up to q parameters), the method optimizes an analytical function which expresses a mathematical relation making it possible to obtain one or more “criteria” Ci on the basis of the takeoff parameters and of the flight plan data.

A “criterion” Ci can be a parameter associated with the trajectory, such as the fuel consumption. More generally, a criterion Ci can result from the “aggregation” of a plurality of reference criteria.

The criteria CiRef are the “original” criteria, i.e. homogeneous in nature (acoustic noise, emission of pollutants, fuel consumption, etc) that is to say those associated with the initial non-optimized trajectory, that is to say such as is defined by the published procedure which is in practice given by the air traffic control. The plurality N of criteria CiRef is associated with a plurality of constraints Kj.

A “constraint” Kj or K′j is a ceiling numerical value or limit or bound which confines the various optimization steps (for example a constraint will be a value of acoustic noise not to be exceeded). Examples of constraints comprise for example limit values as regards fuel consumption, acoustic emission limits or limits as regards emission of pollutants.

Certain constraints are initial data (K′j)—given directly or derivable from the flight data—while other constraints are data, denoted Kj, computed in an “intermediate” manner, i.e. derived from the non-optimized trajectory. These constraints Kj become, as it were, “artificial” (from the point of view of their human intelligibility, but are justified by the fact of the interdependants associated with the function in the course of optimization). The steps of the optimization method manipulate these constraints in the same manner but in an underlying and concrete manner certain values are values received when initializing the optimization computation while the others result from intermediate computation steps.

Stated otherwise, the constraints K′j are generally expressed “as are”, it is possible to obtain them directly with the problem data. The other constraints Kj are formalizable only after the step of computing the reference trajectory. For example a constraint of the form “the altitude must be greater than 10000 ft at such and such a waypoint” is an input datum of the problem, which can be provided directly in the optimizer as constraint K′j. By contrast, a constraint of the form “the optimized flight must not make more noise than the reference flight” is of type Kj since in order to formalize it numerically and provide it to the optimization step, the step of computing the non-optimized trajectory must have been performed beforehand.

The constraints Kj can be determined on the basis of the criteria CiRef. For example, a constraint Kj can be the noise measured by a microphone during the integration of the non-optimized trajectory.

The obtaining of the (intermediate) constraints Kj on the basis of the non-optimized trajectory does not exist in the prior art.

By means of the definition of one or more composite criteria Ci by means of the original criteria CiRef, knowing the original constraints K′j and then the intermediate constraints Kj, it is possible to determine one or more takeoff parameters Pi (between 1 and q). This determination is performed by minimizing a mathematical function which transforms the takeoff parameters Pi into the criteria Ci. In particular, the determination of the value of a criterion Ci can be performed in various ways. The criterion Ci can be determined iteratively by numerical integration. This numerical integration may for example be done by solving differential equations on the basis of said mission data and of the parameters Pi.

The iterative algorithm minimizes the value of Ci obtained by aggregation of the CiRef, while ensuring compliance with the constraints Kj and K′j. At each iteration, Ci is estimated by numerical integration of a system of differential equations on the basis of said mission data and of said parameters Pi resulting from the previous iteration.

In one development, the integer number q of parameters Pi is iteratively incremented by one unit starting from the value 1.

The method optimizes in an incremental manner, from 1 up to q takeoff parameters Pi.

In one embodiment, at least one optimized parameter “P1opt” can be used as input to a flight management computer. As the computation of the steps of the method progresses, a growing number of optimized parameters Pi are determined.

In one embodiment, the method comprises steps of refining the solutions, characterized in that, if a number n of parameters Pi have to be optimized, then the iterative algorithm is launched several times, each time increasing the number q of parameters to be optimized and “forcing” the others to chosen values so as to allow the numerical integration computations to progress properly. The results obtained with each launch of the iterative algorithm are stored. The final result provided by the method is the one which, among all those that have been stored, gives the lowest cost while complying with the constraints.

The various iterations make it possible to progressively refine the results of the optimization. With N criteria Pi to be optimized in total, the number q of parameters is progressively increased (from 1 to N parameters). During the iterations, the values of the non-optimized parameters are fixed at values allowing the numerical integration computations to progress properly.

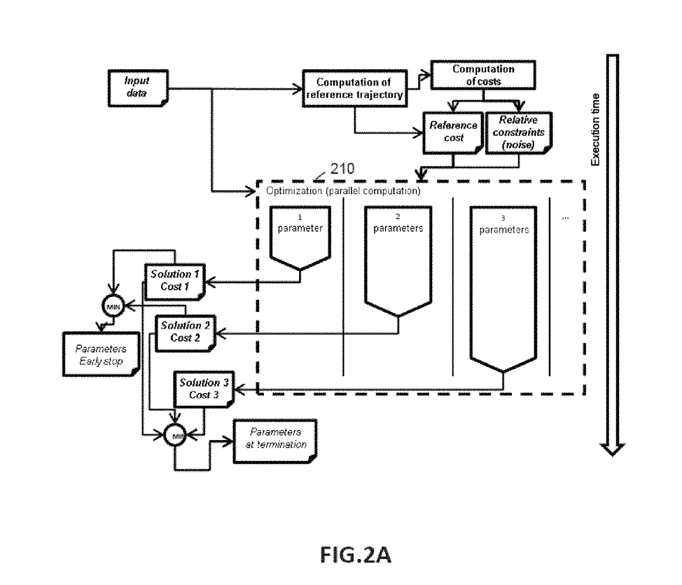

In FIG. 2A, the computation is performed in parallel 210 (firstly on a single parameter, and then two parameters simultaneously, and then three, etc; each time the minimization of the function determines a solution i.e. a minimum cost; the various local results or minima are thereafter compared with one another so as to identify a global minimum). In FIG. 2B, the computation is performed in a sequential manner 220 (the various parameters are determined individually, i.e. the various Pi chosen from among q are optimized independently of one another; various solutions are obtained at output, from among which an optimal solution is determined).

In one development, said incremental iteration is interrupted on the request of the pilot.

In an optional embodiment, the incremental iteration is interrupted on the request of the pilot (or of a third-party flight management system or by any other system interacting with the method according to the invention), which may for example wish to obtain an intermediate result faster than is necessary in order to obtain a finalized optimization. If relevant, should the optimization iterations be interrupted, the completed intermediate results are accessible (and a local minimum can be identified and then restored), only the unfinished intermediate result being unusable. Advantageously, this embodiment affords the pilot fast access to a result which although not finalized may be in a state of convergence sufficient for the operational navigation needs thereof. It is good or indeed noteworthy practice in a man-machine interaction or interface system to allow anticipated outputs so as to avoid infinite loops, but still more, to make it possible by design to “hand over” to the human if the latter considers it necessary. Context elements may partly or entirely escape the automated system. An interruption of the method therefore competes to improve flight safety and efficiency. In the absence of interruption, i.e. if the pilot waits for the end of the computations such as are determined by the method, the final result delivered by the method is that exhibiting the lowest cost (and which by design complies with the flight constraints).

In one development, the criterion Ci is an analytical function of criteria CiRef.

The method iteratively minimizes the value of a criterion Ci, which criterion can be a “non-homogeneous” i.e. “synthetic” criterion, for example “aggregating” or “encapsulating” or “weighting” one or more original (homogeneous) criteria CiRef. The iterative optimization of this criterion Ci is then and always performed while ensuring compliance with the “intermediate” constraints Kj and with the constraints K′j.

The “inter-relation” of the various CiRef can be performed in various ways.

In a first embodiment, an analytical function can govern this inter-relation. An example of aggregation then consists in defining a scalar function J of several criteria CiRef for example of the form:

J=J(FU,Ns₁,NOx,CO₂,EW)

This function may be linear or non-linear.

In one development, said at least criterion Ci is a weighted linear combination of criteria CiRef.

In another embodiment, this analytical function J can be reduced to a linear combination of criteria CiRef. For example, the function J can correspond to a linear combination with constant real coefficients of these various values of the form:

$$J = a \cdot FU + {\sum }_{j = 1}^{n} {b}_{i} \cdot {Ns}_{i} + c \cdot NOx + d \cdot {CO}_{2} + e \cdot EW$$

This embodiment is advantageously fast to compute. The various coefficients can correspond to policies of the airlines (a configuration file can capture these priorities, which may nonetheless be modifiable, i.e. dynamic).

In one development, a criterion Ci is a criterion selected from among the criteria comprising the fuel consumption, the acoustic noise level measured substantially at ground level, the quantitative and/or qualitative emission of one or more chemical compounds, the level of engine wear.

In one embodiment, a criterion Ci is associated with the fuel consumption at a point defined as being representative of the first cruising level. This point may for example be defined as a point at the cruising altitude at a sufficiently significant distance from the takeoff point in such a way that the cruising altitude can be attained even with the slowest reasonably conceivable climb (denoted FU mass unit).

In one embodiment, a criterion Ci is associated with the acoustic noise level measured substantially at ground level. Indeed, one or more microphones placed in the immediate neighborhood of the departure airport can evaluate this noise. This noise level may for example correspond either to a maximum pressure level for a frequency filter of type A (measurement LaMax), or one of the usual exposure measurements (SEL or EPNL) (denoted Nsᵢ, i varying for each point and type of measurement, units dB or dBA). The perceived noise can be measured or computed (simulated). The expression covers the developments of psycho-acoustic perception.

In one embodiment, a criterion Ci is associated with the quantitative and/or qualitative emission of one or more chemical compounds. For example, a chemical compound can comprise nitrogen oxide. The level of nitrogen oxide discharged along the trajectory can be evaluated by a method such as the “Boeing Fuel Flow Method II” in an altitude slice in which these emissions will have an impact on the quality of the local air of the built-up area in which the aerodrome is situated (denoted NOx mass unit). A chemical compound can also comprise carbon dioxide. The level of carbon dioxide discharged by the trajectory can be evaluated in various ways. In a conventional combustion process, this amount is proportional to the fuel consumption, with a proportionality factor dependent on the type of fuel employed (denoted CO₂ mass unit).

In one embodiment, a criterion Ci is associated with the level of engine wear. This engine wear can be associated with the takeoff power level applied and with the duration of use of this power level (denoted EW).

In one development, a criterion Ci is associated with a combination of at least two criteria selected from among the criteria comprising the fuel consumption, the acoustic noise level measured substantially on the ground, the acoustic noise level measured substantially at ground level, the quantitative and/or qualitative emission of one or more chemical compounds, the level of engine wear.

In one embodiment, a criterion Ci can be a “synthetic” or “composite” criterion. Stated otherwise, the weighting of the objectives pursued by the flight can be defined upstream (for example, the pilot or the airline performing the flight of the aircraft can define a specific “mix” reflecting the importance and/or the priority between various sub-criteria (e.g. fuel 60%-noise 20%-engine wear 20%). The various sub-criteria may be basically at least partially interdependent, but the isolation into categories nonetheless advantageously allows effective readability and control of the flight of the aircraft.

In one development, the step consisting in minimizing the criterion Ci comprises a gradient descent.

A variety of optimization (here minimization) algorithms can be used (e.g. cost function, gradient descent or other).

In one development, the method furthermore comprises a step consisting in determining an optimal number of parameters Pi.

In so far as the optimization of the parameters Pi can progress to its term (for example without interruption on the part of the pilot), it is possible to determine a compromise between the computation time allocated to the optimization properly speaking, the number of takeoff parameters determined and their significance. For example, 3 seconds may be necessary to determine P1, P2 and P3 with associated confidence intervals, while 120 seconds would be necessary to establish P1, P2, P3 and P4 with a better confidence interval). As a function of efficiency criteria pertaining to the optimization per se, it is possible to control the method according to the invention.

In one development, a parameter Pi is selected from among the parameters comprising one or more altitudes characteristic of the trajectory profile, one or more speeds characteristic of the trajectory profile, one or more control parameters of the engines characteristic of the trajectory profile.

In one development, the method furthermore comprises a step consisting in communicating said determined parameters Pi.

For example, the determined parameters Pi can be communicated to a flight management system or FMS.

There is disclosed a computer program product, said computer program comprising code instructions making it possible to perform one or more of the steps of the method, when said program is executed on a computer.

In one development, the system comprises means for the implementation of one or more of the steps of the method.

In one development, the system comprises non-avionic means of electronic flight bag EFB type.

In general, the computational capabilities of the FMS system properly speaking not generally being sufficiently fast, the method will in certain cases be able to be advantageously implemented on systems which are peripheral to the FMS core (which is the certified avionics part). The implementation of the method in, on or via a flight tablet EFB will be particularly advantageous (an EFB can access virtually unlimited computational capabilities via the Cloud). Thus, in one embodiment, computation means (e.g. a server or a computer such as a tablet or an EFB) separate from the FMS perform the complete optimization. In another embodiment, the FMS performs a simplified pre-optimization (e.g. q=1 or 2), and computation means separate or (logically, typologically) remote from the FMS perform the remaining optimization (and then communicate the results to the pilot or to the FMS via MMIs for example). In one embodiment, the optimization is done entirely or in part by a server situated in the airplane (for example partitioned off in an electronic module situated in a bay). In one embodiment, the optimization is done entirely or in part by a server situated on the ground (for example that of an airline or of a service provider). In one embodiment, the optimization is done entirely or partially under cloud computing (the tablet/EFB/FMS then being only a terminal in the MMI sense).

Certain embodiments may resort to “Cloud computing”. In the takeoff and/or climb phase terrestrial computation resources may remain accessible (e.g. airport or airline computation infrastructure), with latency times which are reasonable or appropriate to the constraints of the method according to the invention. Allowing intensive computation (e.g. peak or peak capacity involving numerous computations for a short time), the remote computing resources (“Cloud”) accessed may be public resources (the computations and/or data will then be enciphered) and/or private resources. The latency times (e.g. time required to communicate data between the various computation tasks) can be managed by means of data caches, mechanisms for “load-balancing” (of priorities of the computation tasks between the contributing processors).

The embodiments of the invention are described in detail hereinafter.

The optimization according to the method is aimed at simultaneously optimizing several “objectives” or “criteria”, which may be (partly or entirely) contradictory. The optimization can be termed “multi-objective” or “multi-criteria”. Examples of objectives or of criteria comprise in particular as regards the quantity of fuel consumed, the emission of pollutants, the noise perceived on the ground and the wear of the engines. The objectives or criteria are target values. Each flight trajectory (computed or simulated or flown) is associated with “components”, which are data which make it possible to define a flight trajectory. The components are therefore effective or intermediate values. Certain values may become “constraints”, that is to say limit values to be complied with (e.g. not to be exceeded such as a noise level, or a minimum reduced thrust).

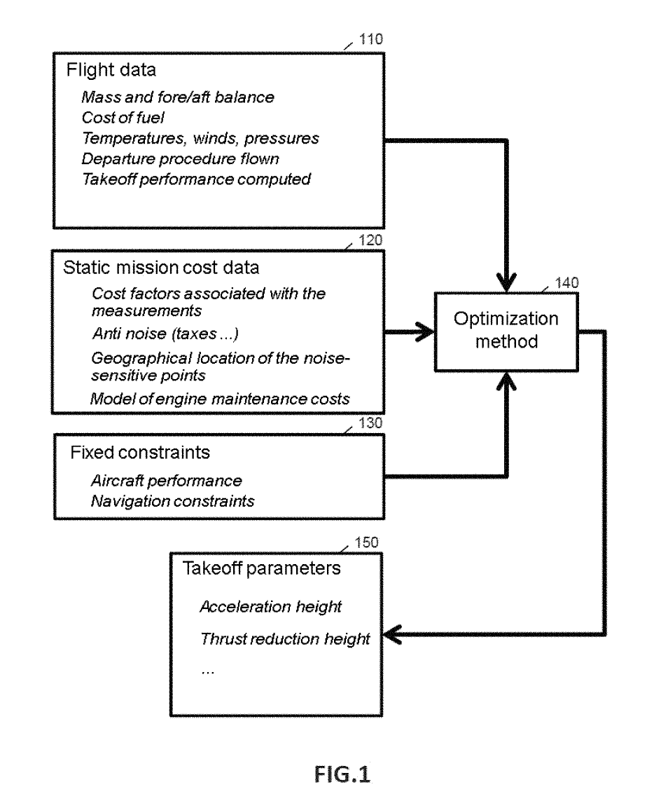

FIG. 1 shows a basic diagram of the invention. The diagram illustrates in particular the input and output data for the determination of the trajectory.

The precise operation of the invention comprises the following steps:

On the basis of the data of the flight or of the mission 110 (for example the conditions of the day in terms of mass and fore/aft balance, fuel cost, temperature and wind data, etc), the method computes by a method, in particular of numerical integration, the trajectory which would be flown by the airplane without any optimization. It deduces therefrom the various components or parameters or characteristics associated with the operational cost of this trajectory: for example, the fuel consumed, the noise measured on the ground, the wear of the engines. On the basis of these components, the method determines constraints having to be complied with (for example the noise emitted by the non-optimized trajectory, which will constitute a limit not to be exceeded) during the flight.

The method continues via an optimization step 140, taking as input the mission data, the constraints computed in the previous step and initial flight control parameters. This step provides the values of the control parameters to be applied while ensuring that the cost of a trajectory flown with these control parameters will be less than that of the non-optimized trajectory, and that the constraints will be properly complied with.

The optimization step combines (i) steps of optimization (ii) steps of numerical integration of one or more differential equations and steps (iii) consisting in iterating these computations so as to refine these solutions and converge to an optimal solution.

More precisely, the steps aimed at refining the solutions obtained (the general optimization process) consist in separating the problem to be solved into several simpler problems: if n parameters are to be optimized, the method launches n computations, each time increasing the number of parameters and fixing the other parameters at values allowing the numerical integration computations to progress properly. This repetition of steps carried out in a progressive manner while adding to the number of parameters to be optimized is called “aggregation”. Each time a computation has terminated, the result of the computation is saved. Optionally, the result is displayed on the request of the operator. When all the computations have terminated, the best result is displayed (in one embodiment, the best result is that which gives the best saving; other criteria can be used).

The underlying advantages are described hereinafter. A computation which optimizes more parameters makes it possible to hope for a slightly greater saving (but with no guarantee of success), but at the price of a greater computation time. By launching computations of increasing complexity, it is almost certain that an optimal solution will be obtained in a very short time. For example, in ten seconds, a solution is obtained covers at least 80% of the savings, this already being satisfactory if the pilot does not have much time; in thirty seconds of computations a solution is obtained which covers at least 90% of the savings, if relevant, etc. In the eventuality that the pilot were to have sufficient time to let the computations run in their entirety, it is possible to obtain the most optimal solution (which is not necessarily the last one computed). In the case where the pilot's time is counted, he obtains a solution which may be found to be sub-optimal, but which despite everything is better than in the total absence of optimization.

In one embodiment, the various computations corresponding to the steps of the method are executed in a parallel manner on various processors or cores of processors of a computer, thereby making it possible to speed up the computations. Examples of parallelization of the computations are illustrated hereinafter.

FIGS. 2A and 2B illustrate examples of computations conducted in parallel or in series, for example according to an implementation with several processors or processor cores.

FIG. 2A shows that the computations can be performed in parallel. FIG. 2B shows that the computations are performed in series, i.e. in a sequential manner.

The optimization (the unitary optimization processes) is based on a coupling between (a) the optimization algorithm, (b) the numerical trajectory integration and (c) the estimation of the costs.

The trajectory integration process (b) takes as input the mission data and the control parameters, and provides a trajectory utilized by the cost estimation steps (c). The optimization algorithm (a) searches iteratively for the control parameters that must be provided to the trajectory integration (b) in order that the cost (c) be a minimum while complying with the constraints provided.

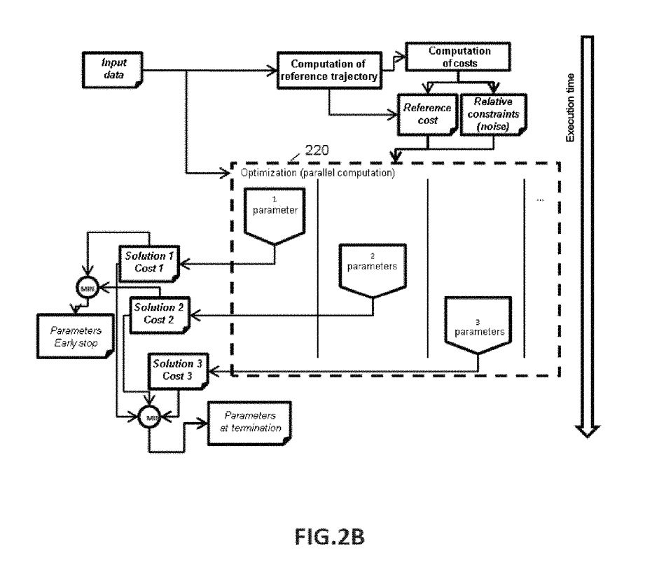

FIG. 3 illustrates examples of sub-steps in respect of the optimization. On the basis of the mission data 301, a set of optimized or optimal parameters 302 is returned. The optimization algorithm is designated by the term “parametric optimizer” 310. This parametric optimizer 310 interacts with a trajectory determination module 320 and a cost determination module 330. Examples of sub-steps carried out by the components 310, 320 and 330 are detailed hereinafter.

The mission data 301 correspond to the information provided as input which is necessary and sufficient for determining the sought-after optimal trajectory. Exterior conditions may indeed apply to the trajectory. These may for example comprise meteorological conditions or else the existence of particular operational restrictions. A set of initial conditions defines totally or partially the dynamic state vector of the airplane at the start of the trajectory (example: mass on takeoff). A set of terminal conditions defines totally or partially the dynamic state vector of the airplane at the end of the trajectory (example: distance traveled).

In a first step, there is undertaken a simulated-trajectory computation 320, that is to say the simulation of the dynamics of the airplane on the departure trajectory with a performance model defined as a system of first-order differential equations. This simulation follows a route defined by a set of navigation procedures and is constrained by the regulatory limitations of these procedures. Limit speeds constitute an example thereof. The airplane's performance is characterized by the description of the aerodynamic and propulsive phenomena.

In a second step, there is undertaken the establishment of the parametric representation of the control applied to the simulation. This parametric representation corresponds to the instructions which will be communicated to the crew and to the automatic piloting device during the execution of the trajectory.

The set of constraints associated with the departure procedure flown (this type of procedure and their computer coding being for example defined in the ARINC 424 standard) comprises, in particular, waypoints and course settings, upper and lower altitude bounds, limitations of speed and of overfly zones, public procedures for reducing sound nuisance, etc.

In a third step, the numerical simulation and optimal control problem is transcribed into a constrained parametric optimization problem. For example, such a process can be a so-called “direct shooting” process associated with a 4^{th}-order Runge-Kutta numerical integration scheme.

In a fourth step, a model of the cost of the trajectory 330 is determined in which the history of the state vector of the airplane along the trajectory is converted into a scalar value representing a deciding cost for the airplane operator. This cost is the value that the method described seeks to minimize.

In a fifth step, the parametric optimization 310 is undertaken, based on the evaluation of the gradient of the cost function with respect to the parameters, together with the evaluation of the Jacobian matrix of the constraint vector with respect to the optimization parameters. This makes it possible not only to handle constraints of equality type (example: attainment of a waypoint at a fixed altitude) but also constraints of inequality type (example: flight domain limits). An illustration of methods of this type is a quasi-Newton method with management of a set of active constraints.

At output, the optimizations having been carried out, a set of optimal parameters 302 is obtained.

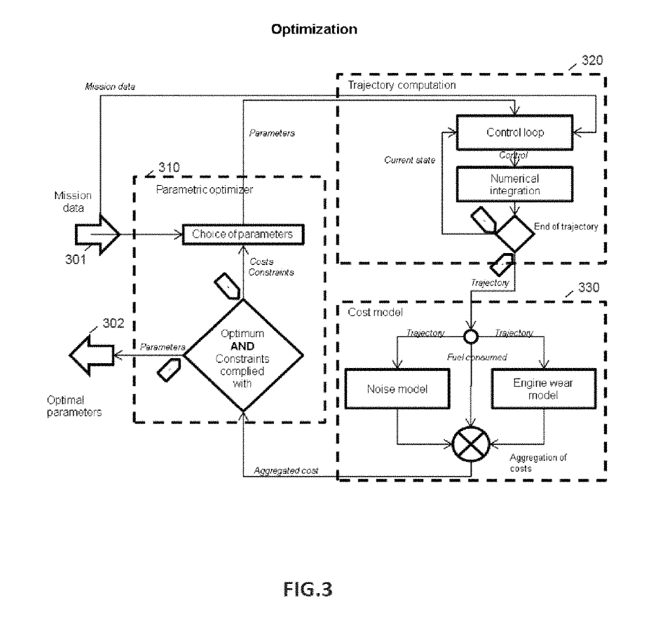

FIG. 4 illustrates fuel consumption as a function of altitude and of distance flown.

In one embodiment, a constraint Ci can be associated with the fuel consumption measured at a point defined as representative of the first cruising level. This point may for example defined as a point situated at the cruising altitude and according to a sufficiently significant distance from the takeoff point, for example in such a way that the cruising altitude can be attained even with the slowest reasonably conceivable climb (denoted FU mass unit).

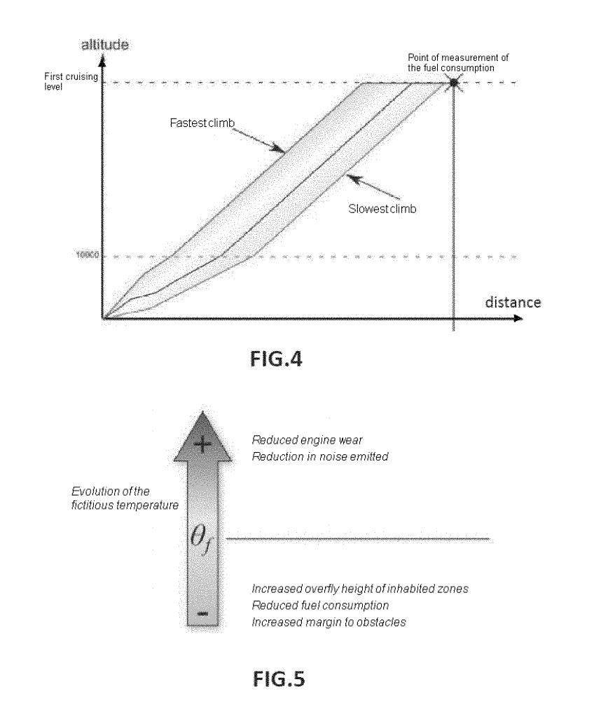

FIG. 5 illustrates the evolution of the fictitious temperature. A reduced thrust is expressed by this fictitious temperature Band results from the optimization of the performance computation on takeoff so as to decrease the wear of the propulsion system. This value is computed in such a way as to be as high as possible while complying with the safety constraints. Nonetheless the fictitious temperature has only consequences on the wear of the engines.

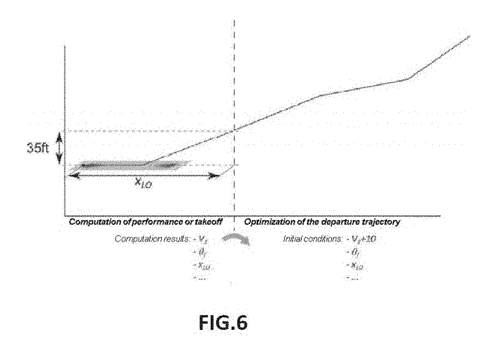

FIG. 6 illustrates an example of taking the fictitious temperature into account to optimize the trajectory.

In a scheme in which the fictitious temperature is solely the result of the performance computation on takeoff, sub-optimal initial conditions are taken into consideration for the computation of the optimized trajectory.

By making the reduced thrust (i.e. the fictitious temperature) an additional optimization parameter over the entirety of the departure trajectory this trajectory can be adjusted in such a way as to best reduce the engine wear while avoiding a prohibitive overconsumption of fuel (consumption increasing as the thrust decreases).

The cost of the engine wear can be modeled. In particular it can be defined as being a function of the history of various variables, comprising in particular the rating of the engine on takeoff, the exterior temperature during takeoff, the ambient pressure and the Mach number.

In one embodiment, the level of the engine wear is determined as a function of the history of variables chosen from the group comprising the rating of the engine on takeoff, the exterior temperature during takeoff, the ambient pressure and the Mach number.

In one development, the modeling of the cost of the engine wear is defined as a function of the history of the following variables: (i) the engine rating on takeoff expressed either as a value of the rotation speed of the fan (N₁), or as the magnitude for controlling the engine power regulation; (ii) the exterior temperature during the takeoff phase (taken for example as the temperature at ground level) (θₑₓₜ), (iii) the ambient pressure (P) and (iv) the Mach number (M).

In a variant embodiment, the engine wear can therefore be defined by analyzing the impact of the history of use of a fleet of engines on the associated maintenance fees for the operator.

The engine rating on takeoff may for example be expressed as a value of the rotation speed of the fan (N₁), or else as the magnitude for controlling the engine power regulation. The exterior temperature can be that measured during the takeoff phase (taken for example as the temperature at ground level) (θₑₓₜ). The pressure can be the ambient pressure (P). The Mach number is denoted (M).

The cost function associated with the engine wear then takes the form:

EW=EW(N₁(t),θₑₓₜ,P,M)

This engine wear can be defined by analyzing the impact of the history of use of a fleet of engines on the associated maintenance fees for the operator.

In one embodiment, the level of the engine wear is therefore estimated as a function of the maintenance costs.

In a variant embodiment, the engine wear is formulated by calling Tf the date of transit at the point defined previously for the consumption measurement, according to:

$$EW = {\int }_{{T}_{0}}^{{T}_{f}} [ {EW}_{c} ( {N}_{1} , {θ}_{ext} , {P}_{ext} , M ) + {EW}_{d} ( {N}_{1} , {θ}_{ext} , {P}_{ext} , M ) ] dt$$

In one embodiment, the level of the engine wear therefore comprises a wear contribution and a damage contribution.

Writing it in the form of an integral therefore reveals a contribution from wear EW_{c} (e.g. creep in the stressed hot parts) and from damage EW_{d} (local exceeding of a limit). This damage term may for example be represented by a Dirac distribution.

The choice of such parameters is suitable for a turbojet or a turbofan. In the case of a turboprop or an internal combustion engine (Wankel, pistons, etc.) airplane, the drive parameter may be replaced with a more appropriate combination of parameters, such as for example, the engine torque and the rating, the intake pressure and the pitch of the propeller, the nozzle or turbine inlet temperature, etc.

In a variant, the form of these functions can be devised on the basis of economic models of the servicing of the engines, for example as a function of their use (according to the servicing contract with the supplier of the motorization wherein the servicing fees will be fixed as a function of the thrust level applied integrated over time, etc).

In one embodiment, the mission data comprise the length of runway consumed and the second-segment speed. Indeed, in a complementary and optional manner, the takeoff performance computation can be introduced into the optimization process. The values principally concerned are, the length of runway consumed and the second-segment speed, both being dependent on the value of takeoff thrust when applying reduced thrust.

In one embodiment, the mission data comprise a thrust value. In one embodiment, the thrust value is the authorized maximum value of reduced thrust. The reduced thrust (expressed by a fictitious temperature θ_{f}) is the result of the optimization of the computation of performance on takeoff so as to decrease the wear of the propulsion system and is computed in such a way as to be as high as possible while complying with the safety constraints. Nonetheless the fictitious temperature only has consequences on the wear of the engines. In a scheme in which the fictitious temperature is solely the result of the computation of performance on takeoff, sub-optimal initial conditions are therefore imposed for the computation of the departure trajectory. By making this reduced thrust an additional optimization parameter over the entirety of the departure trajectory this trajectory can be adjusted so as to best reduce the engine wear while avoiding a prohibitive overconsumption of fuel (consumption increasing as the thrust decreases). The impact of the takeoff distance is also determinant in the noise level perceived in the vicinity of the aerodrome.

The present invention can be implemented on the basis of hardware and/or software elements. It can be available as a computer program product on a computer readable medium.

In a variant embodiment, one or more steps of the method according to the invention is implemented in the form of computer program hosted on a laptop computer of “EFB” (Electronic Flight Bag) type.

In a variant embodiment, the computer program implementing the invention can be implemented in the form of two interacting computer programs: a first program (client) hosted on a portable computer (for example an EFB or a touchpad tablet) and a second program (server) hosted on a computer, the two computers communicating through a network (dedicated or by Internet). According to this configuration, the client can receive the missions data, transmit them to the server, receive in response the optimized parameters and present them on a man-machine interface. The server can receive the mission data, carry out one or more steps of the method according to the invention, and transmit the results of the computation to the client.

In a variant embodiment, one or more steps of the method can be implemented within a computer of FMS type (or in an FM function of a flight computer).

More precisely, within the framework of an implementation within a flight computer (“Flight Management System” or FMS), on the basis of the flight plan defined by the pilot (e.g. a list of transit points called “waypoints”), a so-called lateral trajectory is computed as a function of the geometry between the waypoints (commonly called legs) and/or the altitude and speed conditions (which are used for the computation of the turning radius). Over this lateral trajectory, the FMS optimizes a vertical trajectory (in terms of altitude and speed), passing through possible altitude, speed, time constraints. The whole of the information input or computed by the FMS is grouped together on display screens (MFD pages, NTD and PFD, HUD or other visualizations). The invention can be in particular be carried out by the TRAJPRED part.

1. A method for optimizing the trajectory of an aircraft, comprising the steps of:
receiving a non-optimized initial trajectory according to a published flight procedure;
determining one or more reference criteria CiRef on the basis of said non-optimized initial trajectory; said criteria CiRef being determined for the takeoff and/or climb portion of said non-optimized initial trajectory;
determining one or more initial constraints K′j on the basis of the non-optimized initial trajectory;
determining a criterion Ci according to an analytical function of said criteria CiRef; and,
per iteration cycle,
determining an optimized trajectory;
determining intermediate constraints K′j on the basis of said optimized trajectory;
minimizing said criterion Ci determined under the initial constraints K′j and the intermediate constraints K′j;
determining q takeoff parameters Pi.

2. The method as claimed in claim 1, the integer number q of parameters Pi being iteratively incremented by one unit starting from the value 1.

3. The method as claimed in claim 2, said incremental iteration being interrupted on the request of the pilot.

4. The method as claimed in claim 1, the criterion Ci being an analytical function of criteria CiRef.

5. The method as claimed in claim 1, said at least criterion Ci being a weighted linear combination of criteria CiRef.

6. The method as claimed in claim 1, a criterion Ci being a criterion selected from among the criteria comprising the fuel consumption, the acoustic noise level measured substantially at ground level, the acoustic noise level measured substantially at ground level, the quantitative and/or qualitative emission of one or more chemical compounds, the level of engine wear.

7. The method as claimed in claim 1, a criterion Ci being associated with a combination of at least two criteria selected from among the criteria comprising the fuel consumption, the acoustic noise level measured substantially at ground level, the quantitative and/or qualitative emission of one or more chemical compounds, the level of engine wear.

8. The method as claimed in claim 1, the step consisting in of minimizing the criterion Ci comprising a gradient descent.

9. The method as claimed in claim 1, furthermore comprising a step of determining an optimal number of parameters Pi.

10. The method as claimed in claim 1, a parameter Pi being selected from among the parameters comprising one or more altitudes characteristic of the trajectory profile, one or more speeds characteristic of the trajectory profile, one or more control parameters of the engines characteristic of the trajectory profile.

11. The method as claimed in claim 1, furthermore comprising a of communicating said determined parameters Pi.

12. A computer program product, said computer program comprising code instructions making it possible to perform the steps of the method as claimed in claim 1, when said program is executed on a computer.

13. A system comprising means for implementing the steps of the method as claimed in claim 1.

14. The system as claimed in claim 13, comprising non-avionic means of electronic flight bag EFB type.
